(19) United States
(12) Patent Application Publication
(10) Pub. No.: US 2019/0257363 A1
(43) Pub. Date: Aug. 22, 2019

(54) TRIPOD ROLLER AND TRIPOD JOINT

(71) Applicant: Schaeffler Technologies AG & Co. KG, Herzogenaurach (DE)

(72) Inventors: Jean-Philippe Dietrich, Drusenheim (FR); Christophe Walliser, Haguenau (FR); Xavier Mehul, Rosheim (FR)

(73) Assignee: Schaeffler Technologies AG & Co. KG, Herzogenaurach (DE)

(21) Appl. No.: 16/347,698

(22) PCT Filed: Sep. 22, 2017
(86) PCT No.: PCT/DE2017/100806

§ 371 Date: May 6, 2019

(30) Foreign Application Priority Data
Nov. 7, 2016 (DE) 10 2016 221 707.0

(51) Int. Cl. F16D 3/205

(52) U.S. Cl. CPC F16D 3/2055; F16D 2003/2026

(57) ABSTRACT

A tripod roller is used in a tripod joint having a joint outer part and a joint inner part with three supporting pins. The tripod roller is placed on at least one of the three supporting pins. The tripod roller includes an inner ring, an outer ring, and may include an intermediate ring. The inner ring is placed on a supporting pin. An outer surface of the outer ring bears against the joint outer part. At least one interface between the sliding pin, the inner ring, the intermediate ring, if present, and the outer ring forms a sliding bearing.

### CROSS-REFERENCE TO RELATED APPLICATIONS

This application is the U.S. National Phase of PCT Appln. No. PCT/DE2017/100806 filed Sep. 22, 2017, which claims priority to DE102016221707 filed Nov. 7, 2016, the entire disclosures of which are incorporated by reference herein.

### TECHNICAL FIELD

The disclosure relates to a tripod roller and to a tripod joint having the tripod roller.

### BACKGROUND

A tripod roller is known from DE 44 29 479 C2, for example. The known roller has an outer roller which is rotatable on a needle bearing about a roller carrier. The tripod roller is part of a tripod joint. The latter has an inner part, supporting pins for the tripod rollers, the tripod rollers, and an outer part. The outer rollers are mounted on the joint inner part such that they are supported with respect to the joint inner part on the joint inner part so as to be rotatable about an axis of rotation and roll in a track of the joint outer part. The known tripod rollers are formed from the outer roller, an inner ring (roller carrier), and a rolling bearing. The rolling bearing is a roller bearing or needle bearing arranged radially between the inner ring and the outer roller.

EP 1 726 839 A1 discloses a tripod roller which has no inner ring. Here, the needle bearing is arranged radially between the outer roller and the surface of the supporting pin.

### SUMMARY

It is an object of the disclosure to specify an improved tripod roller and an improved tripod joint.

The tripod roller serves as intended to be placed onto a supporting pin of a tripod joint. Here, the tripod joint has a joint outer part and a joint inner part. The joint inner part comprises three supporting pins. With the tripod roller mounted as intended in the tripod joint, said tripod roller is thus placed onto one of the supporting pins. The tripod roller comprises an outer ring. The outer ring extends around an axis of rotation or has such an axis of rotation. The outer ring can be applied to the joint outer part by way of its outer surface which is directed radially outward—here and in the following with respect to the axis of rotation. In the mounted state, the outer surface thus bears against the joint outer part or rolls during operation on a track on the joint outer part.

The tripod roller comprises an inner element. The inner element is arranged radially within the outer ring. The inner element has a radially inwardly directed inner surface. The inner element can be placed by way of this inner surface on the supporting pin of the tripod joint. In the mounted state, the inner element is thus placed onto the supporting pin. The tripod roller comprises at least one surface of a sliding bearing. Here, in the mounted state or during operation, the sliding bearing serves for rotation of the outer ring about the axis of rotation relative to the supporting pin. In the mounted state, the outer ring is thus rotatable, by virtue of the sliding bearing, about the axis of rotation relative to the supporting pin. Here, the tripod roller can comprise one or more sliding bearings or at least one of the sliding surfaces of these sliding bearings.

The use of a sliding bearing makes it possible to reduce the production costs of the tripod roller or of the tripod joint. Corresponding machines for inserting the needles become unnecessary. The production can be accelerated.

In a preferred embodiment, the inner surface comprises a first sliding surface of the sliding bearing. To form the sliding bearing, the first sliding surface can be placed onto a second sliding surface on the supporting pin. In other words, the tripod roller bears half of the sliding bearing. The sliding bearing is formed in the mounted state as intended and contains its second half formed in the form of a second sliding surface on the supporting pin, onto which second sliding surface the first sliding surface is placed. The sliding bearing is thus formed between tripod roller and supporting pin. This is a particularly simple possibility for constructing tripod rollers.

In a preferred embodiment, the outer ring has a radially inwardly directed first sliding surface of the sliding bearing. The inner element has a radially outwardly directed second sliding surface of the sliding bearing. The second sliding surface is seated on the first sliding surface, with the result that the sliding surfaces together form the sliding bearing. According to this embodiment, the sliding bearing is formed between the outer ring and the inner element and is completely situated within the tripod roller. Consequently, no interaction between tripod roller and supporting pin with respect to the sliding bearing has to be taken into account.

In a preferred embodiment, the inner element can be a one-piece component. The inner element—in particular as a one-piece component—can also be referred to or understood as a sliding ring, in particular if in each case a sliding bearing is provided both between outer ring and inner element and between inner element and supporting pin.

In a preferred embodiment, the inner element comprises an inner ring. The inner ring has the aforementioned inner surface. The inner element also comprises an intermediate ring. The intermediate ring is arranged radially between inner ring and outer ring. A first sliding surface on the outer ring and a second sliding surface on the intermediate ring then form a sliding bearing. Alternatively or additionally, a first sliding surface on the intermediate ring and a second sliding surface on the inner ring form a sliding bearing. Consequently, the sliding bearing is again formed within the tripod roller, but now between outer ring and inner element and/or within the inner element. The intermediate ring can also be referred to or understood as a sliding ring.

Both the outer ring and/or the inner ring and/or the intermediate ring can in each case be constructed in one piece in preferred embodiments.

In a preferred variant of this embodiment, the intermediate ring is rotationally fixed relative to the axis of rotation with respect to the inner ring or with respect to the outer ring. Consequently, there is thus only formed a sliding bearing between outer ring and intermediate ring if the intermediate ring is rotationally fixed on the inner ring. On the other hand, a sliding bearing is formed between intermediate ring and inner ring if the intermediate ring is rotationally fixed on the outer ring.

In a further embodiment, a corresponding rotational fixing is also possible for a one-piece inner element. This, too, can be rotationally fixed with respect to the outer ring or, in the mounted state as intended, be rotationally fixed with respect to the supporting pin. Here, too, the sliding bearing is then formed either between outer ring and inner element or between inner element and supporting pin.

In all these cases, in each case only one sliding bearing is provided, thereby resulting in a particularly cost-effective construction of the tripod roller.

In a preferred variant of this embodiment, the intermediate ring has at least one holding element. The holding element can also be a stop element or be understood as such. The holding element serves for limiting a relative movement in the axial direction of the axis of rotation of the intermediate ring with respect to the inner ring and/or of the intermediate ring with respect to the outer ring. By virtue of the holding element, inner ring or outer ring is thus guided relative to the intermediate ring, and vice versa. Even if the inner element is constructed in one piece, the latter can have such holding or stop elements. These then act between inner element and outer ring and/or—in the mounted state—supporting pin. A relative movement with respect to the outer ring and/or, in the mounted state, with respect to the supporting pin is then limited. Expensive or complicated other securing ring arrangement can thus be replaced by a simple holding element as a solution integrated on the intermediate ring or inner element.

In a preferred embodiment, the tripod roller has at least one sliding surface which contains a low-friction plastic and/or a ceramic and/or a bronze or the like. Such sliding surfaces are particularly suitable for use in tripod rollers. In particular, the entire sliding surface can consist of the respective material. The plastic is in particular an antifriction plastic, such as, for example, PEEK (polyether ether ketone); PTFE (polytetrafluoroethylene), POM (polyoxymethylene) or any comparable material.

In a preferred embodiment, the tripod roller is initially constructed without sliding bearings or sliding surfaces, but with a rolling bearing, in particular needle bearing. The rolling bearing serves for rotation of the outer ring about the axis of rotation relative to the supporting pin in the same way as the sliding bearing. After construction, or in the completely constructed tripod roller, the originally constructed rolling bearing—that is to say its rollers or needles, where appropriate with cage, etc.—is replaced by the inner element. For embodiments with an intermediate ring, the rolling bearing is replaced by the intermediate ring. The tripod roller is thus built up in exactly the same way as a tripod roller with rolling bearing. The rolling bearing is just replaced by a sliding ring, namely in the form of the inner element or intermediate ring. The rolling bearing track on the original tripod roller or at least part thereof then functions as first sliding surface. The second sliding surface is formed on the intermediate ring or inner element. In the case of the inner element, this applies particularly to one-piece inner elements which were formerly constructed as rolling bearings.

According to this embodiment, an originally constructed rolling bearing, in particular needle bearing, is thus replaced by the inner element or the intermediate ring. In other words, the tripod roller is converted from rolling bearing to sliding bearing without modifying its remaining elements in terms of design. Inner element or intermediate ring preferably have the dimensions of the rolling bearing or needle bearing. Thus, any arrangement with rolling or needle bearings can be exchanged for arrangements with intermediate ring or inner element. This has the advantage that all connection components, such as joint outer part, outer roller or outer ring, supporting pin, where appropriate inner ring and the joint inner part, can remain unchanged with such an exchange.

The object is also achieved by a tripod joint. The tripod joint and at least some of its embodiments and the respective advantages have already been explained in conjunction with the tripod roller. The tripod joint comprises the joint outer part and the joint inner part. The joint inner part has the three supporting pins. A tripod roller is placed onto each of the supporting pins. The outer ring of the roller is applied so as to be movable on the joint outer part by way of its outer surface. The inner element of the roller is placed on the supporting pin of the tripod joint by way of its inner surface. The sliding bearing allows rotation of the outer ring about the axis of rotation relative to the associated supporting pin.

By virtue of the installation of the tripod roller, the advantages thereof also apply to the tripod joint.

In a preferred embodiment, the inner surface of the tripod roller comprises a first sliding surface of the sliding bearing. A second sliding surface of the sliding bearing is formed on the supporting pin. The tripod roller is placed on the second sliding surface by way of its first sliding surface. Thus, the combination of tripod roller and the remainder of the tripod joint hence also comprises at least one sliding bearing.

In a tripod roller, a rolling or needle bearing or its rollers or needles is replaced by a ring, in particular intermediate ring, to obtain the same functional properties of the tripod roller. In conventional tripod rollers, the needles or rolling bodies or the like are guided, for example, between two snap rings and run on running surfaces.

This exchange considerably simplifies the tripod roller and a corresponding production line. The exchange avoids some risks of inaccuracies or defects in terms of needle geometry or needle number in the tripod roller or of breakage damage in the tripod roller. A replacement element for the rolling bearing (intermediate ring, etc.) can also increase the loadability by comparison with needles, resulting in a stronger or more load-bearing tripod roller.

In a tripod roller, the intermediate ring occupies the same installation space as rollers or needles in a comparable tripod roller with rolling or needle bearings. The intermediate ring can be freely movable or be blocked or arrested with respect to an internal ring (inner ring, inner element, supporting pin) or external ring (outer ring), for example by press molding or overmolding.

The material of the intermediate ring can be in particular an antifriction plastic (PEEK, PTFE, POM, etc.), but also ceramic or bronze or the like.

In particular, the intermediate ring has sliding bearing quality, or it is a sliding bearing.

### BRIEF DESCRIPTION OF THE DRAWINGS

Further features, effects and advantages will emerge from the following description of a preferred exemplary embodiment and from the FIGURES, in which, in a schematic basic diagram:

FIG. 1 shows a detail of a tripod joint with tripod roller.

### DETAILED DESCRIPTION

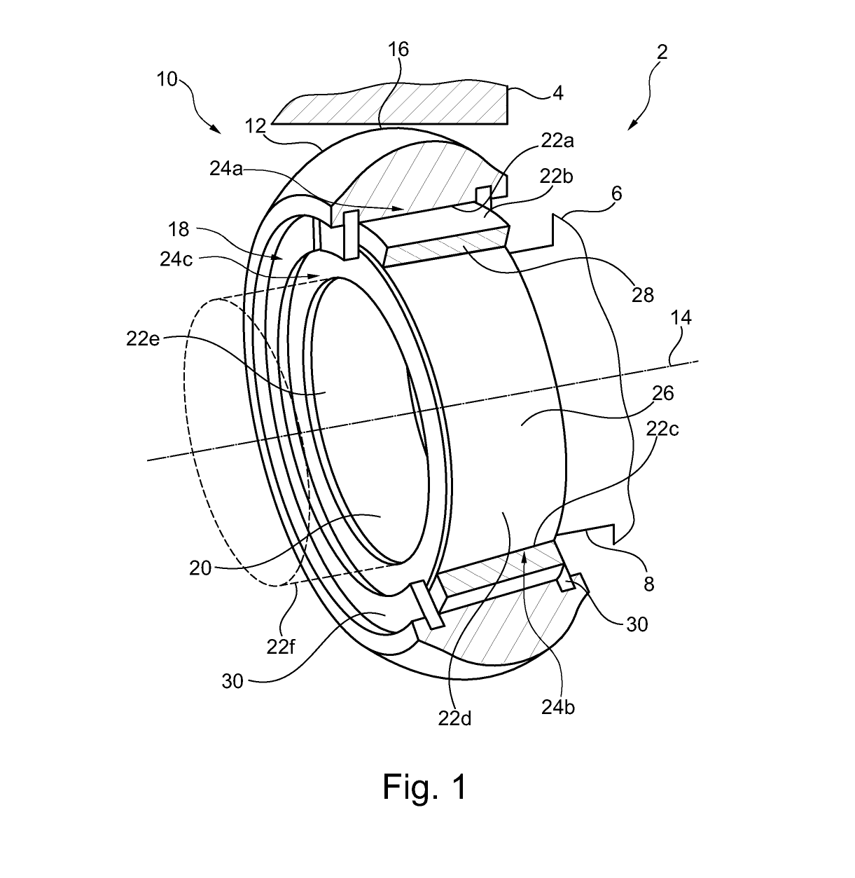

FIG. 1 is a perspective illustration showing, in a merely symbolically indicated manner, a tripod joint 2 having a joint outer part 4 and a joint inner part 6. The tripod joint 2 has a total of three supporting pins 8, a tripod roller 10 being arranged on each of the supporting pins 8. Only one of the three supporting pins 8 and tripod rollers 10 is illustrated in the FIGURE. The tripod roller 10 comprises an outer ring 12 which extends about an axis of rotation 14 or has such an axis of rotation. The tripod roller 10 is applied so as to be movable on the joint outer part 4 by way of its radially outwardly directed outer surface 16, that is to say, during a corresponding movement of the joint, said tripod roller rolls on a track (not explained in more detail) on the joint outer part 4.

An inner element 18 of the tripod roller 10 is arranged radially (with respect to the axis of rotation 14) within the outer ring 12. The inner element 18 is placed on the supporting pin 8 by way of a radially inwardly directed inner surface 20. In the example, the tripod roller 10 has at least one of five sliding surfaces 22a through 22e. The first sliding surface 22a and the second sliding surface 22b form a first sliding bearing 24a. The sliding surface 22a is thus a radially inwardly directed first sliding surface of the sliding bearing 24a. The inner element 18 has the associated second sliding surface 22b, which is directed radially outward of the sliding bearing 24a. The first sliding surface 22a is seated on the second sliding surface 22b. The sliding bearing 24a is thus formed between outer ring 12 and inner element 18.

In the example, the inner element 18 comprises an inner ring 26, which has the inner surface 20, and an intermediate ring 28 which is arranged radially between inner ring 26 and outer ring 12. The sliding bearing 24a is thus formed in concrete terms by the first sliding surface 22a on the outer ring 12 and the second sliding surface 22b on the intermediate ring 28. The sliding bearing 24a is thus formed between outer ring 12 and intermediate ring 28.

Alternatively or additionally, the first sliding surface 22c and the second sliding surface 22d form a sliding bearing 24b. The sliding bearing 24b is formed by the first sliding surface 22c on the intermediate ring 28 and the second sliding surface 22d on the inner ring 26. The sliding bearing 24b is formed between intermediate ring 28 and inner ring 26. The intermediate ring 28 is thus a sliding ring here. The sliding bearing 24b is formed within the inner element 18.

In an alternative embodiment, the inner element 18 is configured in one piece as an individual ring. The sliding bearing 24b can then not be realized.

In an alternative or additional embodiment, the inner surface 20 likewise comprises a first sliding surface 22e. To form a further sliding bearing 24c, said first sliding surface 22e is placed onto a second sliding surface 22f on the supporting pin 8. The sliding bearing 24c is here thus formed between the inner element 18 and the supporting pin 8 and arises only when the tripod roller is mounted as intended on the supporting pin 8.

All three sliding bearings 24a through 24c serve for the outer ring 12 to be mounted relative to the supporting pin 8 so as to be rotatable about the axis of rotation 14.

In alternative embodiments, either the sliding bearing 24a or the sliding bearing 24b is dispensed with, with the result that the intermediate ring 28 is rotationally fixed with respect to the inner ring 26 or the outer ring 12 relative to the axis of rotation 14.

A holding element 30, here a holding ring (not explained in further detail) inserted into the outer ring 12, limits a relative movement of the intermediate 28, inner ring 26 and outer ring 12 with respect to one another in the axial direction of the axis of rotation 14. In an alternative embodiment (not shown), the holding element 30 is provided on the intermediate ring 28.

The sliding surfaces 22a though 22e contain a low-friction plastic or a ceramic or a bronze.

The tripod roller 10 is constructed in such a way that a rolling bearing (not shown) is actually provided at the location of the intermediate ring 28. However, without changing this construction, the rolling bearing is replaced by the intermediate ring 28 illustrated. A corresponding procedure can also be adopted if, in an alternative embodiment, the inner element 18 is configured in one piece as an individual ring. The tripod roller is then constructed as outer ring 12 with a radially inner rolling bearing, the rolling bearing being provided between outer ring 12 and supporting pin 8. However, the rolling bearing is replaced by the inner element 18. The tripod joint 2 and the tripod roller 10 then have one or both of the sliding bearings 24a and 24c.

### LIST OF REFERENCE SIGNS

2 Tripod joint
4 Joint outer part
6 Joint inner part
8 Supporting pin
10 Tripod roller
12 Outer ring
14 Axis of rotation
16 Outer surface
18 Inner element
20 Inner surface
22a-f Sliding surface
24a-c Sliding bearing
26 Inner ring
28 Intermediate ring
30 Holding element

1. A tripod roller for placing onto a supporting pin of a tripod joint, the tripod joint comprising a joint outer part and a joint inner part with three supporting pins, the tripod roller comprising:
an outer ring which extends about an axis of rotation and is configured to be movable on the joint outer part by way of its radially outwardly directed outer surface; and
an inner element which is arranged radially within the outer ring and is configured to be placed on one of the supporting pins by way of a radially inwardly directed inner surface; and
wherein the tripod roller has at least one sliding surface of a sliding bearing for rotation of the outer ring about the axis of rotation relative to the supporting pin.

2. The tripod roller of claim 1, wherein the inner surface is the at least one sliding surface which, to form the sliding bearing, can be placed onto a second sliding surface on the supporting pin.

3. The tripod roller claim 1, wherein the outer ring has a radially inwardly directed first sliding surface of the sliding bearing, and the inner element has a radially outwardly directed second sliding surface of the sliding bearing on which the first sliding surface is seated.

4. The tripod roller of claim 1, wherein the inner element comprises:
an inner ring which has the inner surface; and
an intermediate ring which is arranged radially between inner ring and outer ring; and
wherein two sliding surfaces on the outer ring and intermediate ring form the sliding bearing.

5. The tripod roller of claim 4, wherein the intermediate ring is rotationally fixed with respect to the inner ring.

6. The tripod roller of claim 4, wherein the intermediate ring has at least one holding element for limiting a relative movement of the intermediate ring with respect to the outer ring.

7. The tripod roller of claim 1, wherein at least one of the sliding surfaces of the tripod roller contains a low-friction plastic or a ceramic or a bronze.

8. (canceled)

9. A tripod joint comprising:
a joint outer part
a joint inner part with three supporting pins, wherein a tripod roller is placed onto each of the supporting pins,
at least one of the tripod rollers being a tripod roller as claimed in claim 1, wherein
the outer ring of the tripod roller is applied so as to be movable on the joint outer part by way of its outer surface, and
the inner element is placed on the supporting pin of the tripod joint by way of its inner surface, and
the sliding bearing allows rotation of the outer ring about the axis of rotation relative to the supporting pin.

10. The tripod joint of claim 9, wherein
the inner surface of the tripod roller comprises a first sliding surface of the sliding bearing, and wherein a second sliding surface of the sliding bearing is formed on the supporting pin, onto which second sliding surface the tripod roller is placed by way of its first sliding surface.

11. The tripod roller of claim 1, wherein the inner element comprises:
an inner ring which has the inner surface; and
an intermediate ring which is arranged radially between inner ring and outer ring; and
wherein two sliding surfaces on the intermediate ring and inner ring form the sliding bearing.

12. The tripod roller of claim 11, wherein the intermediate ring is rotationally fixed with respect to the outer ring.

13. The tripod roller of claim 11, wherein the intermediate ring has at least one holding element for limiting a relative movement of the intermediate ring with respect to the inner ring.

14. A tripod joint comprising:
a joint outer part;
a joint inner part with three supporting pins;
an outer ring extending about an axis of rotation and having a radially outwardly directed outer surface movable on the joint outer part; and
an inner element arranged radially within the outer ring and placed on one of the supporting pins by way of a radially inwardly directed inner surface; and
wherein inner element has at least one sliding surface of a sliding bearing for rotation of the outer ring about the axis of rotation relative to the one of the supporting pins.

15. The tripod joint of claim 14, wherein the inner surface is the at least one sliding surface and a surface of the one of the supporting pins is another sliding surface of the sliding bearing.

16. The tripod joint of claim 14, wherein the outer ring has a radially inwardly directed first sliding surface of the sliding bearing, and the inner element has a radially outwardly directed second sliding surface of the sliding bearing on which the first sliding surface is seated.

17. The tripod joint of claim 14, wherein the inner element comprises:
an inner ring which has the inner surface; and
an intermediate ring which is arranged radially between inner ring and outer ring.

18. The tripod joint of claim 17 wherein:
two sliding surfaces on the outer ring and intermediate ring respectively form the sliding bearing, and
the intermediate ring is rotationally fixed with respect to the inner ring.

19. The tripod joint of claim 17 wherein:
two sliding surfaces on the inner ring and intermediate ring respectively form the sliding bearing, and
the intermediate ring is rotationally fixed with respect to the outer ring.

20. The tripod joint of claim 17, wherein the intermediate ring has at least one holding element for limiting a relative movement of the intermediate ring with respect to the inner ring or the outer ring.
